(19) United States
(12) Patent Application Publication
(10) Pub. No.: US 2014/0311620 A1
(43) Pub. Date: Oct. 23, 2014

(54) METHOD FOR VENDING WATER

(71) Applicant: Guy Hancock, Ammon, ID (US)

(72) Inventor: Guy Hancock, Ammon, ID (US)

(21) Appl. No.: 13/866,976

(22) Filed: Apr. 19, 2013

(51) Int. Cl. B67D 1/00

(52) U.S. Cl. CPC B67D 1/0014
USPC 141/2

(57) ABSTRACT

The present invention relates to a method of vending artesian well water or well water with a flavoring to consumers such as, schools, clubs, gyms and offices. Vending water or water with a flavoring generates a convenient, healthy, safe, good tasting, product at a reasonable cost, and protects the environment.

### BACKGROUND

Automated vending machines are a common solution for providing products and services to the general public at minimal cost. A vending machine allows the provider to potentially sell a product, twenty four hours a day, seven days a week, while only visiting the machine to restock the product and collect money. A partial list of products that are typically vended include, candy, gum, snacks, chips, sandwiches, pizza, over the counter medications, hygiene products and drinks. The drinks are typically provided in bottles or cans and may include soft drinks, sports drinks, flavored water, and water. Vending machines providing bottled water are everywhere and bottled water is a great product to sell. Water at the source may be free or is typically very inexpensive, packaging costs are minimal and the price charged typically exceeds the cost of a similar amount of crude oil.

Water is an essential element that people must obtain daily to maintain hydration and proper body function. In many parts of the world, drinking water is scarce and distribution of the water is poorly managed. As a consequence, the water system may harbor bacteria, parasites or other harmful micro-organisms or may be contaminated with pollutants. In most of the United States, we take water for granted; there is plenty for drinking and for, personal, household, agricultural, and industrial use. The water provided in culinary water systems is typically considered safe to drink straight from a faucet or fountain.

However, there are areas where the public water system is unsafe or the public may decline to drink the water even though it passes all governmental tests or standards. Water may be considered undrinkable when it develops an undesirable taste or smell resulting from dissolved minerals in the aquifer. In other areas, the water is treated but still contains trace elements of harmful, naturally occurring, heavy metals, such as, arsenic, lead, cadmium or mercury. Other, public wells or aquifers have been contaminated due to industrial surface pollution such as, oil or gas or spills, chemical solvent leaks or illegal dumping of chemical or petroleum waste. Water may be contaminated underground due to drilling or mining activity. In most major metropolitan areas, all waste water is collected, classified, filtered, treated with ultra-violet light and chemicals and then recirculated in the culinary water supply. In such areas, the public may use the water supply for household uses, such as watering lawns and gardens, bathing, and washing clothing but, due to health concerns, or taste preferences, they will only drink filtered or bottled water.

Bottled water is regulated by the United States Food and Drug Administration (FDA) which ensures the public that the water has safe mineral or chemical content and the water is handled in a hygienic manner. However, bottled water does have other concerns. Bottled water does cost money and while store brands are affordable, some of the “exotic” bottled waters, from faraway places, are quite expensive. Bottled water still tastes like water, and much of the public prefers to consume sugary flavored drinks such as, soda or sports drinks. Water stored in plastic bottles for an extended period of time will leach chemicals from the plastic bottle and into the water. The bottled water industry generates millions of waste bottles every day and the bottles have a monetary and environmental cost. Plastic manufacturing requires the use of petroleum and substantial amounts of electricity that could be used for other manufacturing, heating or transportation. While many of the bottles are recycled, millions of the bottles will be placed into landfills. Many of the bottles will end up in the environment as litter on roadsides, in rivers, along trails and there are vast tracts in the oceans that are completely covered by millions of tons of plastic waste. The petroleum based plastic bottles may require hundreds of years for complete decomposition.

What is needed is a method for vending water that provides a convenient safe product; free from dangerous minerals, chemicals, bad taste or smell, with no plastic waste, and at a reasonable cost.

### SUMMARY OF THE INVENTION

The present invention relates to a method of vending water which generates a convenient, healthy, safe, good tasting product that may include a selected flavoring, at a reasonable cost and protects the environment.

One embodiment of the present invention or method of vending water includes, obtaining water from an artesian well that provides an adequate supply of high quality, great tasting water. The water must be pure from the source and, free from chemical, metal, or biological contamination. The water is pumped into a tank for transportation. The tank may be a configured as a tanker truck having a storage tank attached directly to the frame or the tank maybe a stand-alone tank configured to be secured into the back of a pick-up truck. The tank is made from a material that will not contaminate or taint the water during transport. It contemplated that the tank will be a plastic or stainless steel. The water will be transported, as needed, directly from the artesian well to the vending site where the water will be off-loaded into another smaller tank attached to a dolly or hand-truck. The vendor will transport the water in the smaller tank to the vending machine where it will be transferred via hose into the vending machine.

The vending machine is configured to include an internal storage tank having a capacity to store enough water for two or more days of vending. Water stored is kept fresh using a ultra-violet (UV) light sanitation device. Additionally, the water passes through a refrigeration heat exchanger to ensure that the water is served at an ideal temperature for consumption.

A buyer will deposit the required payment into the machine to obtain water. The buyer may use bills or coins to pay for the service. The currency handling system has the capacity to recognize the coins or bills inserted into the machine and will provide the correct payment credit towards a single vending transaction, once the transaction is complete, the machine will calculate the cost of the product vended and refund the remaining balance to the user. In yet another embodiment it is contemplated that a user may use some form of electronic payment such as debit card, credit card, payment fob, or smart-phone. Once payment is made, the user will place their personal single serving container under the water discharge to obtain the product. The use of personal serving containers eliminates a substantial amount of post-consumer waste. Re-use has long been recognized as a more sustainable “green” option versus recycling.

In another embodiment of the present invention the vending machine includes the option of adding flavoring to the dispensed water for an additional fee. In one embodiment, there is an option to choose one of three natural flavors which is added to the single serving of water. In yet other embodiments the user may choose from more than three flavors or may choose multiple flavors which may be added as a blended combination into the vended water. In one embodiment, the user will be prompted to fill their personal water container under the water discharge nozzle and then move the container under one of a plurality of the flavor nozzles where a selected flavor will be added. It is contemplated that in yet another embodiment of the present invention, the flavor or a combination of flavors will be selected by the user and then added by a flavor nozzle, or nozzles, that inject the natural flavor additive directly into the water stream discharged from the water discharge nozzle.

In one embodiment of the present invention the vendor will provide the vending machine directly to an institution such as a, junior high school, high school, college, university, sports club, gym or business. Providing vended water and vended flavored water gives the public an alternative to high calorie soft drinks and sports drinks and when the public to reuses their own container, they are making a decision that is not only good for their body, but good for the environment. Water vended into reusable containers can be offered to buyers at a lower cost than bottled water while still maintaining reasonable profits for the vendor.

The reusable containers may be glasses, bottles, cans, bladders, or flasks comprised of materials such as, aluminum, stainless steel, plastic, polycarbonate or glass. It is preferable that the aluminum bottles are lined to prevent oxidation and possible metals contamination and that any polycarbonate or plastic bottles are bisphenol A (BPA) free. In one embodiment of the invention the vendor will provide reusable single serving containers to the institution for resale to the buyers. The institution may use reusable bottle sales as a profit center or may allow specific groups to host sales for fund raising. The containers may have a color scheme that represents the school, gym, club or company or may include emblems or logos that represent the institution. It is contemplated that the reusable containers may be sold by the vendor in a kiosk or machine located near the water vending machine, and via the internet.

One embodiment of the present invention or method of vending water, the vending machine will include electronic monitoring and communications. The vending machine will monitor; number of purchases made, cash, the water reservoir level, remaining syrup for each natural flavor and water temperature. The information may be transmitted to the vendor using a telephone, network, internet or wireless connection. It is contemplated that information would be manually uploaded by the vendor, automatically uploaded at a set time interval or when an “alarm” level is reached for the water or flavorings. It is contemplated that the monitoring information may be downloaded to software that stores historical data and tracks information like, number transactions, rate of transactions, number of water purchases, number of flavoring purchases by flavor, and expected money currently in the machine. The software may also be used to calculate projections for timing the refill of the water reservoir or flavoring bottles.

In one embodiment of the present invention water is transferred from the manual dolly or hand-truck tank to the vending machine reservoir using gravity feed. In other embodiments the water may be transferred using a manual pump or an electric pump using a battery power supply or using an electrical extension cord connected to an electrical receptacle.

In one embodiment of the present invention the water is from a culinary water source and is filtered or treated, as necessary, for optimal taste and or mineral or chemical content. The treated water will be delivered to the vending machine using the same procedural steps as artesian water.

In yet another embodiment of the present invention water supplied to the vending machine may come from a culinary source connected directly to the water vending machine. The incoming water would be filtered prior to discharging into the storage reservoir. It is contemplated that the filtration may include, but is not limited to, media filters, activated carbon, ceramic, and reverse-osmosis semi-permeable membranes. Filtration would remove all sediments, metals, chemicals and biological organisms and the activate carbon filter would eliminate undesirable tastes or odors. In this embodiment the transportation elements of the water handling are eliminated however, the vendor would be required to maintain the filtration system and periodically change the filter elements.

These and other features and advantages of the disclosure will be set forth and will become more fully apparent in the detailed description that follows and in the appended claims. The features and advantages may be realized and obtained by the instruments and combinations particularly pointed out in the appended claims. Furthermore, the features and advantages of the disclosure may be learned by the practice of the methods or will be obvious from the description, as set for herein.

### Equipment List

For example the method of vending water may be accomplished by the following major processing equipment:

1. Artesian water source,

2. Water truck or water tank attached to a truck,

3. Hand truck or dolly mounted water tank,

4. Natural flavors, and,

5. Water vending machine.

### BRIEF DESCRIPTION OF THE DRAWINGS

The following description of the embodiments can be understood in light of the Figures, which illustrate specific aspects of the embodiments and are part of the specification. Together with the following description, the Figures demonstrate and explain the principles of the embodiments. In the Figures the physical dimensions of the embodiment may be exaggerated for clarity. The same reference numerals in different drawings represent the same element, and thus their descriptions may be omitted.

FIG. 1 is a flow chart showing a method of vending water, and,

FIG. 2 illustrates a front view of a water vending machine.

### DETAILED DESCRIPTION OF THE INVENTION

For the purposes of promoting an understanding of the principles in accordance with the disclosure, reference will be made to the embodiments illustrated in the drawings and specific language will be used to describe the same. It will nevertheless be understood that no limitation of the scope of the disclosures is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

As used in this specification and the appended claims, the singular forms “a,” “an,” and “the” include plural referents unless the context clearly dictates otherwise. In describing and claiming the present disclosure, the following terminology will be used in accordance with the definitions set out below. As used herein, the terms “comprising,” “including,” “containing,” “characterized by,” and the grammatical equivalents thereof are inclusive or open-ended terms that do not exclude additional, unrecited elements of method processes.

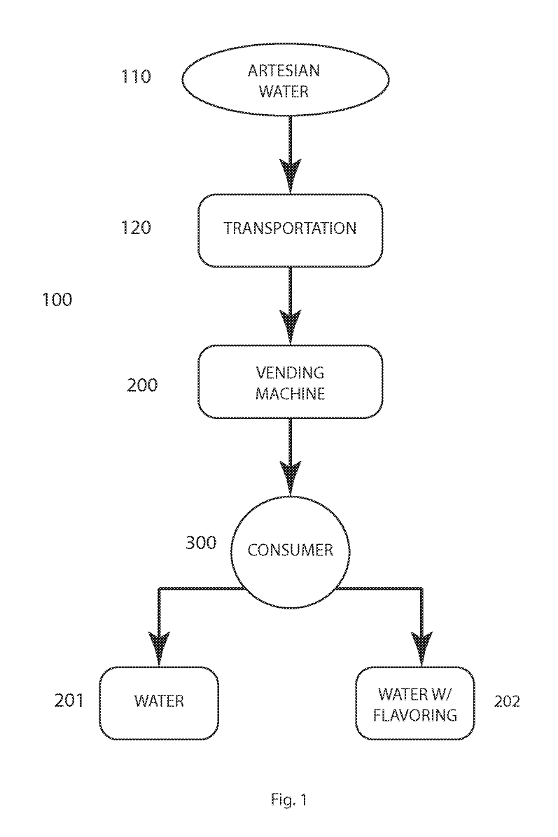

FIG. 1 is a flow chart outlining a method for vending water 100 including finding an artesian water supply 110 having adequate flow of pure water that is free from contaminants and any bio-organisms. Water from the artesian supply 110 is transferred into a truck, or truck mounted water tank, for transportation 120. Water is transferred from the bulk tank on the truck to a tank mounted on a rolling dolly or hand truck, allowing the vendor to move water into areas not accessible to vehicle traffic, such as school buildings, gyms, clubs or offices. The water will be transferred from the rolling tank to a vending machine 200. The transportation process will be repeated by the vendor as necessary to resupply vending machine 200 with water. The consumer 300 may select water 201 or water with natural flavoring 202 from vending machine 200.

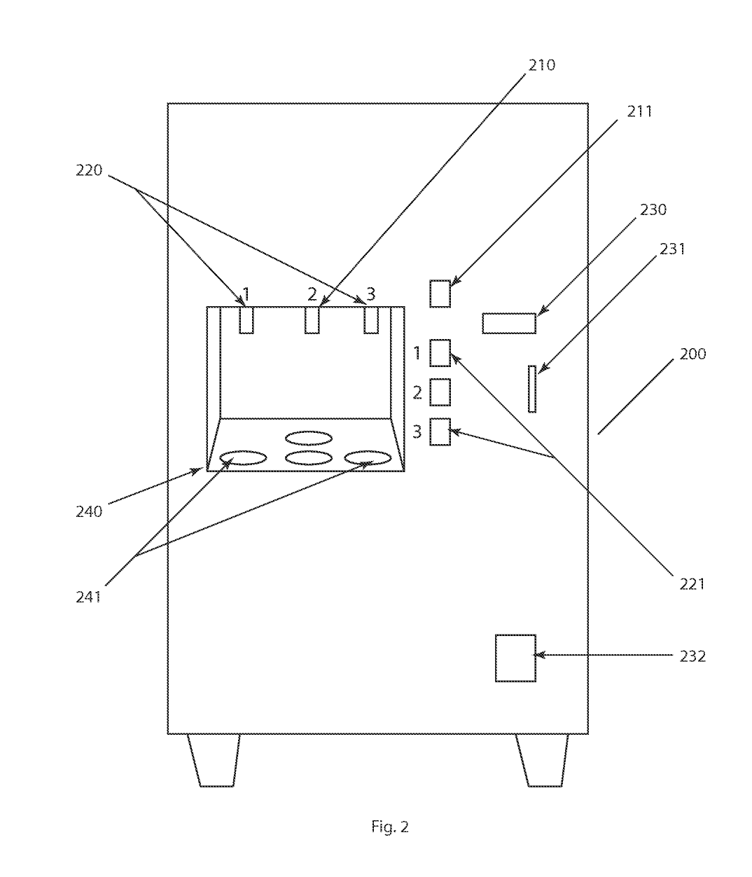

FIG. 2 is a front view of vending machine 200 used for vending water 201 or water with natural flavoring 202. The vending machine 200 including, a water discharge nozzle 210 and a plurality of flavoring discharge nozzles 220. When the consumer desires to make a purchase, the consumer will place coins into coin slot 231 or paper currency into the bill exchanger 230 and then place a reusable, single serving, container (not shown) onto the appropriate target 241 on service shelf 240. The consumer will press water service button 211 to discharge water into the container, if the consumer desires a flavoring, they will move their container to the target corresponding to the desired flavoring and then press the appropriate flavoring service button 221. Once the product has been vended any change due the customer will be produced in change chute 232. Vending machine 200 has storage capacity allowing for at least 2 two days of vending between re-supplying the reservoir. A UV sanitation unit will treat all of the water and the water will pass through a refrigeration unit prior vending, to ensure the product is safe and refreshing.

1. A method for vending water comprising:
providing an artesian water source,
providing a vending machine comprising;
an internal storage tank,
a UV sanitation device,
a refrigeration unit,
a water discharge nozzle,
a means for payment, and,
a means to initiate water vending,
transferring the water from the water source into a transport vehicle tank,
filling the vending machine internal storage tank with the water in the transport vehicle tank,
a consumer initiates a vend comprising;
providing payment,
providing a reusable single serving container,
placing the container under the water discharge nozzle,
activating the means to initiate water vending wherein,
a single serving of water from the internal storage tank flows through the UV sanitation unit, through the refrigeration unit and is discharged through the water discharge nozzle into the serving container, and,
removing the serving container,
inspecting the internal water storage tank water level, and, when necessary, refilling the internal storage tank comprising;
transferring the water from the water source into a transport vehicle tank, and,
filling the vending machine internal storage tank with the water in the transport vehicle tank.

2. The method of claim 1 including providing a means of dispensing a plurality of flavorings.

3. The method of claim 2 including a means to purchase and select water with one of the plurality of flavorings.

4. The method of claim 2 including a means to purchase and select water with a blend of more than one of the plurality of flavorings.

5. The method of claim 1 including providing a means to transfer water by hand from the transport vehicle tank to the internal storage tank of the vending machine.

6. The method of claim 5 wherein the means to transfer water by hand includes one of a tank mounted on a dolly and a tank mounted on a hand truck.

7. A method for vending water comprising:
providing an artesian water source,
providing a vending machine comprising;
an internal storage tank,
a UV sanitation device,
a refrigeration unit,
a water discharge nozzle,
a plurality of flavorings,
a means of dispensing a plurality of flavorings,
a means for payment,
a means to initiate water vending, and,
a means to initiate water vending with at least one of the plurality of flavorings, transferring the water from the water source into a transport vehicle tank,
filling the vending machine internal storage tank with the water in the transport vehicle tank,
a consumer initiates a vend comprising;
providing payment,
providing a reusable single serving container,
placing the container under the water discharge nozzle,
selecting the means to initiate water vending or selecting the means to initiate water vending with at least one of the plurality of flavorings, wherein,
a single serving of water from the internal storage tank flows through the UV sanitation unit, through the refrigeration unit and is discharged through the water discharge nozzle into the serving container,
if the means to initiate water vending with at least one of the plurality of flavorings is selected,
at least one of the plurality of flavors is discharged into the serving container, and,
removing the serving container,
inspecting the internal water storage tank water level, and, when necessary, refilling the internal storage tank comprising;
transferring the water from the water source into a transport vehicle tank, and,
filling the vending machine internal storage tank with the water in the transport vehicle tank.

8. The method of claim 7 including a means to purchase and select water with a blend of more than one of the plurality of flavorings.

9. The method of claim 7 including providing a means to transfer water by hand from the transport vehicle tank to the internal storage tank of the vending machine.

10. The method of claim 9 wherein the means to transfer water by hand includes one of a tank mounted on a dolly and a tank mounted on a hand truck.

11. A method for vending water comprising:
providing a vending machine comprising;
a culinary water source,
a filtration system,
a UV sanitation device,
a refrigeration unit,
a water discharge nozzle,
a plurality of flavorings,
a means of dispensing a plurality of flavorings,
a means for payment,
a means to initiate water vending, and,
a means to initiate water vending with at least one of the plurality of flavorings,
a consumer initiates a vend comprising;
providing payment,
providing a reusable single serving container,
placing the container under the water discharge nozzle,
selecting the means to initiate water vending or selecting the means to initiate water vending with at least one of the plurality of flavorings, wherein,
a single serving of water from the culinary water source flows through the filtration system, through the UV sanitation unit, through the refrigeration unit and is discharged through the water discharge nozzle into the serving container,
if the means to initiate water vending with at least one of the plurality of flavorings is selected,
at least one of the plurality of flavors is discharged into the serving container, and,
removing the serving container.

12. The method claim 11 wherein the filtration system includes at least one of, media filtration, ceramic filter, activated carbon and reverse osmosis.
